(19) United States
(12) Patent Application Publication
(10) Pub. No.: US 2025/0383615 A1
(43) Pub. Date: Dec. 18, 2025

(54) DEVELOPING CARTRIDGE INCLUDING DEVELOPING ELECTRODE WHICH INCLUDES CONNECTION PORTION AND CONTACT SURFACE

(71) Applicant: BROTHER KOGYO KABUSHIKI KAISHA, Nagoya (JP)

(72) Inventor: Koji ABE, Okazaki (JP)

(73) Assignee: BROTHER KOGYO KABUSHIKI KAISHA, Nagoya (JP)

(21) Appl. No.: 19/314,430

(22) Filed: Aug. 29, 2025

Related U.S. Application Data
(63) Continuation of application No. PCT/JP2024/009004, filed on Mar. 8, 2024.

(30) Foreign Application Priority Data
Mar. 17, 2023 (JP) 2023-042761

(51) Int. Cl. G03G 15/08; G03G 15/00; G03G 21/16; G03G 21/18

(52) U.S. Cl. CPC G03G 15/0896; G03G 15/0808; G03G 15/0812; G03G 15/0889; G03G 15/80; G03G 21/1652; G03G 21/1814; G03G 21/1821; G03G 2215/0816; G03G 2221/163

(57) ABSTRACT

A developing cartridge includes: a housing; a developing roller; a blade; and a developing electrode. The housing is configured to accommodate toner. The housing has one end portion and an other end portion in a first direction. The developing roller includes a developing shaft extending in a second direction. The blade is placed on an outer circumferential surface of the developing roller. The developing electrode includes: a connection portion electrically connected to one end portion of the developing shaft in the second direction; and a contact surface positioned apart from the connection portion in a third direction crossing both the first direction and the second direction. The contact surface is electrically connected to the connection portion. The contact surface is positioned opposite the blade with respect to the developing shaft in the third direction.

### REFERENCE TO RELATED APPLICATIONS

This is a by-pass continuation application of International Application No. PCT/JP2024/009004 filed on Mar. 8, 2024 which claims priority from Japanese Patent Application No. 2023-042761 filed on Mar. 17, 2023. The entire contents of the International Application and the priority application are incorporated herein by reference.

### BACKGROUND ART

An image forming apparatus such as a laser printer or an LED printer is known. A developing cartridge is used in the image forming apparatus. The developing cartridge includes a developing roller. When the developing cartridge is attached to the image forming apparatus, a voltage is supplied to the shaft of the developing roller from the image forming apparatus. And then, toner is carried onto the outer circumferential surface of the developing roller by the electrostatic force generated by the voltage supplied to the shaft.

A known developing cartridge which includes a developing roller is provided with a power receiving part for supplying a voltage from an image forming apparatus to the shaft of the developing roller.

### SUMMARY

However, the known developing cartridge has room for further improvement.

In view of the foregoing, it is an object of the present disclosure to provide a new developing cartridge that is a further advancement of the existing technology.

In order to attain the above and other object, the present disclosure provides a developing cartridge including: a housing; a developing roller; a blade; and a developing electrode. The housing is configured to accommodate toner. The housing has one end portion and an other end portion in a first direction. The other end portion is apart from the one end portion in the first direction. The developing roller includes a developing shaft extending in a second direction. The developing roller is positioned at the one end portion. The blade is placed on an outer circumferential surface of the developing roller. The developing electrode includes: a connection portion and a contact surface. The connection portion is electrically connected to an end portion of the developing shaft in the second direction. The contact surface is positioned apart from the connection portion in a third direction crossing both the first direction and the second direction. The contact surface is electrically connected to the connection portion. The contact surface is positioned opposite the blade with respect to the developing shaft in the third direction. The contact surface extends in the first direction.

According to another aspect, the present disclosure also provides a developing cartridge including: a housing; a developing roller; a blade; and a developing electrode. The housing is configured to accommodate toner. The housing has one end portion and an other end portion in a first direction. The other end portion is apart from the one end portion in the first direction. The developing roller includes a developing shaft extending in a second direction. The developing roller is positioned at the one end portion. The blade is placed on an outer circumferential surface of the developing roller. The developing electrode includes: a connection portion; and a contact surface. The connection portion is electrically connected to an end portion of the developing shaft in the second direction. The contact surface is positioned apart from the connection portion in a third direction crossing both the first direction and the second direction. The contact surface is electrically connected to the connection portion. The contact surface is positioned further from the blade in the third direction than the developing roller is from the blade in the third direction. The contact surface extends in the first direction.

According to still another aspect, the present disclosure also provides a developing cartridge including: a housing; a developing roller; a blade; and a developing electrode. The housing is configured to accommodate toner. The housing has one end portion and an other end portion in a first direction. The other end portion is apart from the one end portion in the first direction. The developing roller includes a developing shaft extending in a second direction. The developing roller is positioned at the one end portion. The blade is placed on an outer circumferential surface of the developing roller. The developing electrode includes: a connection portion; and a contact surface. The connection portion is electrically connected to an end portion of the developing shaft in the second direction. The contact surface is positioned apart from the connection portion in a third direction crossing both the first direction and the second direction. The contact surface is electrically connected to the connection portion. The contact surface extends in the first direction. In the developing cartridge, the developing shaft is positioned between the blade and the contact surface in the third direction.

According to still another aspect, the present disclosure also provides a developing cartridge including: a housing; a developing roller; and a developing electrode. The housing includes an accommodating chamber in the housing. The accommodating chamber is configured to accommodate toner. The housing has one end portion and an other end portion in a first direction. The other end portion is apart from the one end portion in the first direction. The developing roller includes a developing shaft extending in a second direction. The developing roller is positioned at the one end portion. The developing electrode includes: a connection portion; and a contact surface. The connection portion is electrically connected to an end portion of the developing shaft in the second direction. The contact surface is positioned apart from the connection portion in a third direction crossing both the first direction and the second direction. The contact surface is electrically connected to the connection portion. The contact surface is positioned opposite the accommodating chamber with respect to the developing shaft in the third direction. The contact surface extends in the first direction.

According to still another aspect, the present disclosure also provides a developing cartridge including: a housing; a developing roller; and a developing electrode. The housing includes an accommodating chamber in the housing. The accommodating chamber is configured to accommodate toner. The housing has one end portion and an other end portion in a first direction. The other end portion is apart from the one end portion in the first direction. The developing roller includes a developing shaft extending in a second direction. The developing roller is positioned at the one end portion. The developing electrode includes: a connection portion; and a contact surface. The connection portion is electrically connected to an end portion of the developing shaft in the second direction. The contact surface is positioned apart from the connection portion in a third direction crossing both the first direction and the second direction. The contact surface is electrically connected to the connection portion. The contact surface is positioned further from the accommodating chamber in the third direction than the developing roller is from the accommodating chamber in the third direction. The contact surface extends in the first direction.

According to still another aspect, the present disclosure also provides a developing cartridge including: a housing; a developing roller; and a developing electrode. The housing includes an accommodating chamber in the housing. The accommodating chamber is configured to accommodate toner. The housing has one end portion and an other end portion in a first direction. The other end portion is apart from the one end portion in the first direction. The developing roller includes a developing shaft extending in a second direction. The developing roller is positioned at the one end portion. The developing electrode includes: a connection portion; and a contact surface. The connection portion is electrically connected to an end portion of the developing shaft in the second direction. The contact surface is positioned apart from the connection portion in a third direction crossing both the first direction and the second direction. The contact surface is electrically connected to the connection portion. The contact surface extends in the first direction. In the developing cartridge, the developing shaft is positioned between the accommodating chamber and the contact surface in the third direction.

According to still another aspect, the present disclosure also provides a developing cartridge including: a housing; an agitator; a developing roller; and a developing electrode. The housing is configured to accommodate toner. The housing has one end portion and an other end portion in a first direction. The other end portion is apart from the one end portion in the first direction. The agitator is configured to agitate toner in the housing. The developing roller includes a developing shaft extending in a second direction. The developing roller is positioned at the one end portion. The developing electrode includes: a connection portion; and a contact surface. The connection portion is electrically connected to an end portion of the developing shaft in the second direction. The contact surface is positioned apart from the connection portion in a third direction crossing both the first direction and the second direction. The contact surface is electrically connected to the connection portion. The contact surface is positioned opposite the agitator with respect to the developing shaft in the third direction. The contact surface extends in the first direction.

According to still another aspect, the present disclosure also provides a developing cartridge including: a housing; an agitator; a developing roller; and a developing electrode. The housing is configured to accommodate toner. The housing has one end portion and an other end portion in a first direction. The other end portion is apart from the one end portion in the first direction. The agitator is configured to agitate toner in the housing. The developing roller includes a developing shaft extending in a second direction. The developing roller is positioned at the one end portion. The developing electrode includes: a connection portion; and a contact surface. The connection portion is electrically connected to an end portion of the developing shaft in the second direction. The contact surface is positioned apart from the connection portion in a third direction crossing both the first direction and the second direction. The contact surface is electrically connected to the connection portion. The contact surface is positioned further from the agitator than the developing roller is from the agitator. The contact surface extends in the first direction.

According to still another aspect, the present disclosure also provides a developing cartridge including: a housing; an agitator; a developing roller; and a developing electrode. The housing is configured to accommodate toner. The housing has one end portion and an other end portion in a first direction. The other end portion is apart from the one end portion in the first direction. The agitator is configured to agitate toner in the housing. The developing roller includes a developing shaft extending in a second direction. The developing roller is positioned at the one end portion. The developing electrode includes: a connection portion; and a contact surface. The connection portion is electrically connected to an end portion of the developing shaft in the second direction. The contact surface is positioned apart from the connection portion in a third direction crossing both the first direction and the second direction. The contact surface is electrically connected to the connection portion. The contact surface extends in the first direction. In the developing cartridge, the developing shaft is positioned between the agitator and the contact surface in the third direction.

According to the above structures, a new developing cartridge that is a further advancement of the existing technology can be provided.

### BRIEF DESCRIPTION OF DRAWINGS

FIG. 1 is a schematic view of an image forming apparatus.

FIG. 2 is a perspective view of a drum unit to which four developing cartridges are attached.

FIG. 3 is a perspective view of the drum unit to which the developing cartridges are not attached.

FIG. 4 is a perspective view of the developing cartridge.

FIG. 5 is another perspective view of the developing cartridge.

FIG. 6 is a view illustrating the developing cartridge when viewed in the second direction from a side where a first outer surface is positioned.

FIG. 7 is a cross-sectional view of the developing cartridge taken along a plane orthogonal to the second direction.

FIG. 8 is a view illustrating the developing cartridge with a gear cover removed, when viewed in the second direction from the side where a second outer peripheral surface 12 positioned.

FIG. 9 is a partial perspective view of the developing cartridge in the vicinity of the first outer surface.

FIG. 10 is a cross-sectional view illustrating the intermediate stage of the attachment of the developing cartridge to the drum unit.

FIG. 11 is a cross-sectional view illustrating a state where the attachment of the developing cartridge to the drum unit is completed.

FIG. 12 is a view illustrating the intermediate stage of the attachment of a developing cartridge 1 to a drum unit 2.

FIG. 13 is a view illustrating a state where the attachment of the developing cartridge 1 to the drum unit 2 is completed.

### DESCRIPTION

Hereinafter, an embodiment of the present disclosure will be described while referring to the accompanying drawings.

In the following description, a direction in which one end portion of a housing 10 of a developing cartridge 1 at which a developing roller 30 is positioned, and the other end portion of the housing 10 are arranged will be defined as a “first direction.” A direction in which a developing shaft 32 extends will be defined as a “second direction.” A direction in which a first bearing hole 61 and a contact surface 64 are arranged will be defined as a “third direction.” A direction in which four photosensitive drums 91 are arranged in a drum unit 2 will be defined as a “fourth direction.”

The first direction and the second direction cross each other. Preferably, the first direction and the second direction are orthogonal to each other. The first direction and the third direction cross each other. Preferably, the first direction and the third direction are orthogonal to each other. The first direction and the fourth direction cross each other. The second direction and the third direction cross each other. Preferably, the second direction and the third direction are orthogonal to each other. The second direction and the fourth direction cross each other. Preferably, the second direction and the fourth direction are orthogonal to each other. The third direction and the fourth direction cross each other.

### <1. Configuration of Image Forming Apparatus>

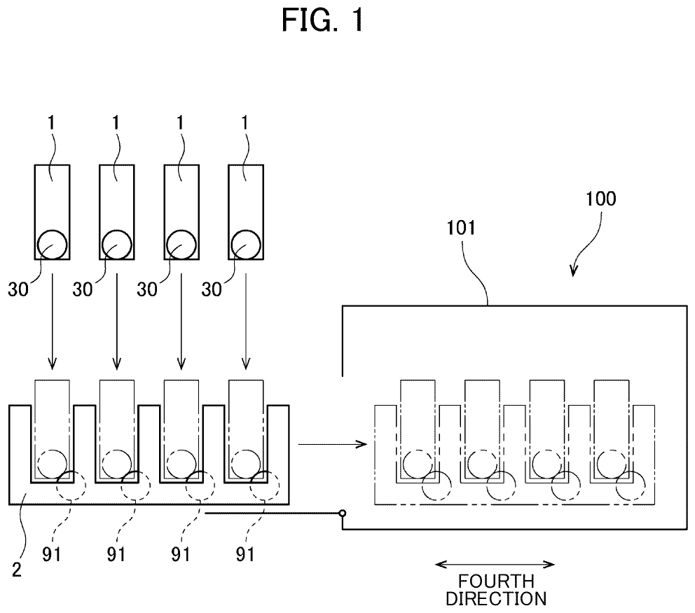

FIG. 1 is a schematic view of an image forming apparatus 100. The image forming apparatus 100 is an electrophotographic printer. Specifically, the image forming apparatus 100 is a laser printer or an LED printer. As illustrated in FIG. 1, the image forming apparatus 100 includes a main frame 101, the drum unit 2, and the four developing cartridges 1.

The four developing cartridges 1 are attachable to the drum unit 2. Also, the drum unit 2 to which the four developing cartridges 1 are attached is attachable to the main frame 101. The drum unit 2 is configured to be attached to the main frame 101 by being slid in the fourth direction relative to the main frame 101.

As an example, the four developing cartridges 1 are arranged in the fourth direction in the order of the developing cartridge 1 storing yellow toner, the developing cartridge 1 storing magenta toner, the developing cartridge 1 storing cyan toner, and the developing cartridge 1 storing black toner. The image forming apparatus 100 is configured to print images on a surface of a printing sheet using toner supplied from the developing cartridges 1.

### <2. Configuration of Drum Unit>

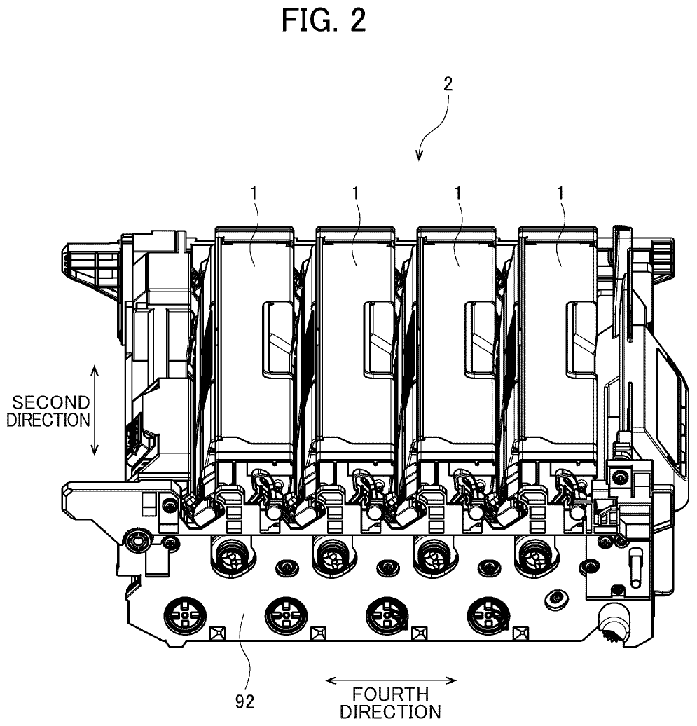

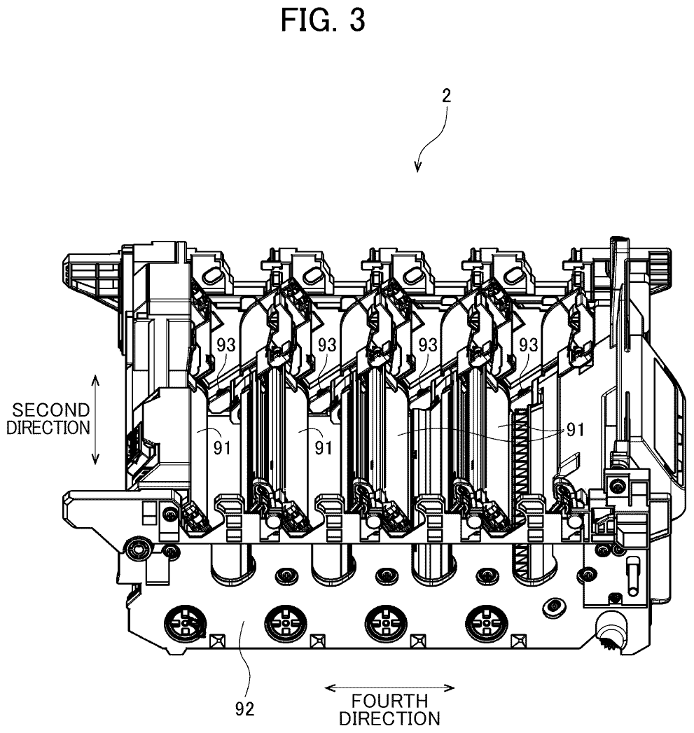

FIG. 2 is a perspective view of the drum unit 2 to which the four developing cartridges 1 are attached. FIG. 3 is a perspective view of the drum unit 2 to which the four developing cartridges 1 are not attached. The drum unit 2 includes the four photosensitive drums 91 and a drum frame 92.

The photosensitive drum 91 is positioned at one end portion of the drum unit 2 in the first direction. The photosensitive drum 91 has an outer circumferential surface. The outer circumferential surface has a cylindrical shape centered on a drum axis extending in the second direction. The outer circumferential surface of the photosensitive drum 91 is covered with a photosensitive material.

As an example, the four photosensitive drums 91 are arranged in the fourth direction in the order of the photosensitive drum 91 corresponding to yellow toner, the photosensitive drum 91 corresponding to magenta toner, the photosensitive drum 91 corresponding to cyan toner, and the photosensitive drum 91 corresponding to black toner. The photosensitive drum 91 corresponding to yellow toner and the photosensitive drum 91 corresponding to magenta toner are spaced apart from each other in the fourth direction. The photosensitive drum 91 corresponding to magenta toner and the photosensitive drum 91 corresponding to cyan toner are spaced apart from each other in the fourth direction. The photosensitive drum 91 corresponding to cyan toner and the photosensitive drum 91 corresponding to black toner are spaced apart from each other in the fourth direction.

The drum frame 92 supports the four photosensitive drums 91 such that the four photosensitive drums 91 are rotatable about their respective drum axes. The four developing cartridges 1 are configured to be attached to the drum frame 92. When each developing cartridge 1 is attached to the drum frame 92, the outer circumferential surface of the developing roller 30 contacts the outer circumferential surface of the corresponding photosensitive drum 91.

As illustrated in FIG. 3, the drum unit 2 includes four drum electrodes 93. Each drum electrode 93 is positioned at one end portion of the drum frame 92 in the second direction. The drum electrode 93 is made of electrically conductive metal. In a state where each developing cartridge 1 is attached to the drum frame 92, the corresponding drum electrode 93 is in contact with a developing electrode 60 of the developing cartridge 1.

### <3. Configuration of Developing Cartridge>

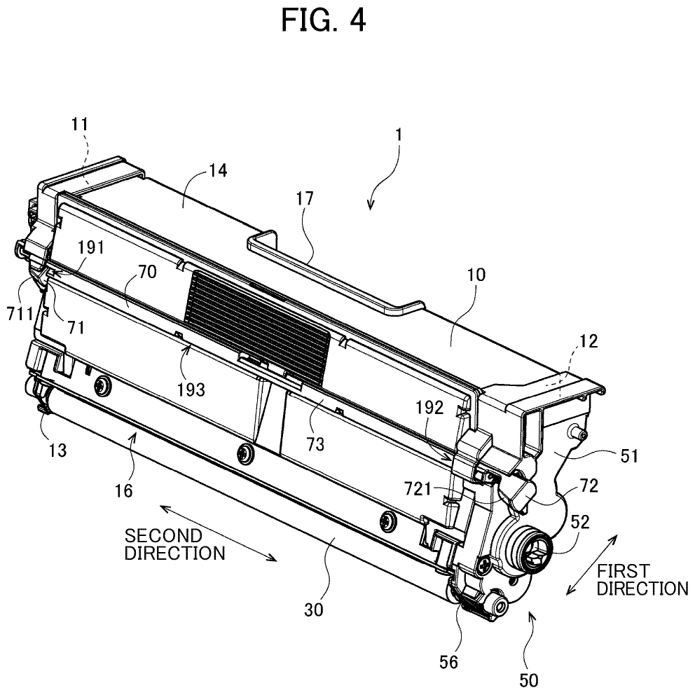

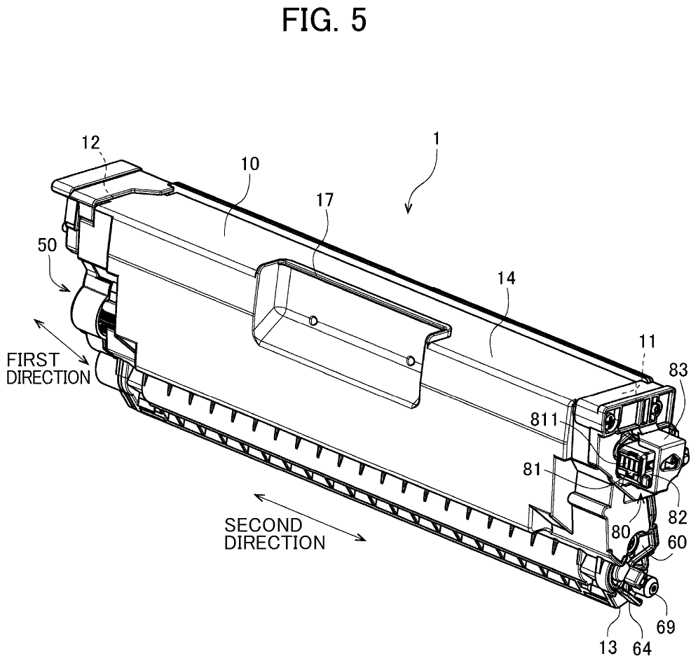

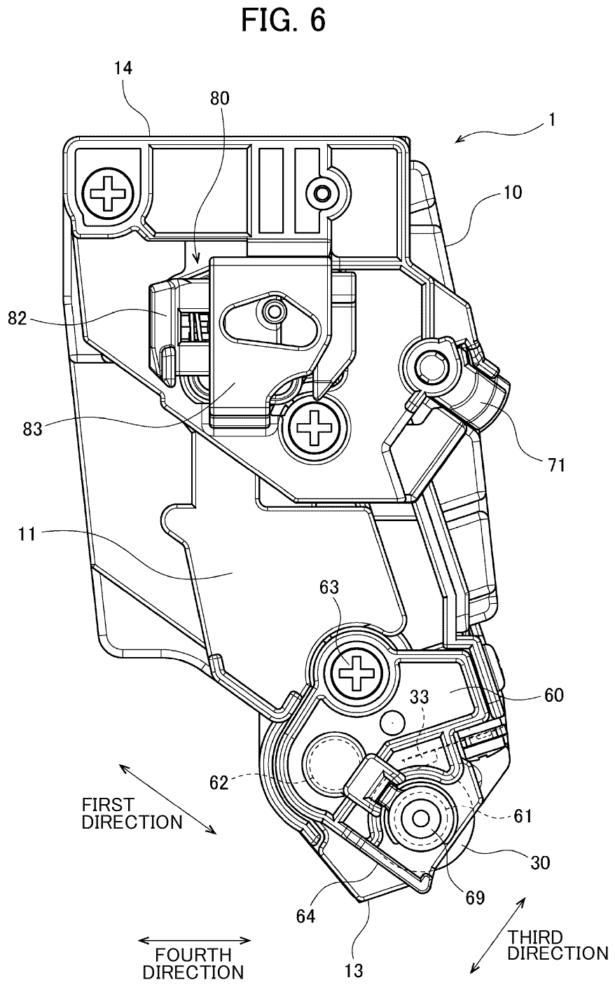

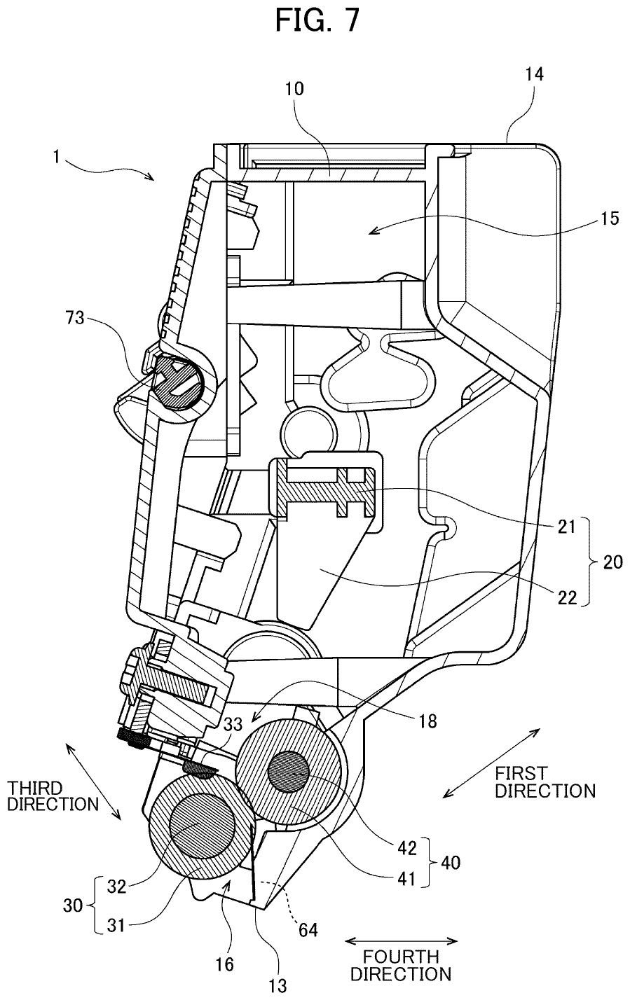

FIGS. 4 and 5 are perspective views of the developing cartridge 1. FIG. 6 is a view illustrating the developing cartridge 1 when viewed in the second direction from a side where a first outer peripheral surface 11 is positioned. FIG. 7 is a cross-sectional view of the developing cartridge 1 taken along a plane orthogonal to the second direction. As illustrated in FIGS. 4 through 7, each developing cartridge 1 includes the housing 10, an agitator 20, the developing roller 30, a supply roller 40, a gear section 50, a memory assembly 80, the developing electrode 60, and a separation member 70.

### <3-1. Housing>

The housing 10 is a container configured to accommodate toner. The housing 10 includes the first outer peripheral surface 11 and a second outer peripheral surface 12. The first outer peripheral surface 11 is positioned at one end portion of the housing 10 in the second direction. The second outer peripheral surface 12 is positioned at the other end portion of the housing 10 in the second direction. The first outer peripheral surface 11 and the second outer peripheral surface 12 are spaced apart from each other in the second direction.

Also, the housing 10 includes a first end portion 13 and a second end portion 14. The first end portion 13 is positioned at one end portion of the housing 10 in the first direction. The second end portion 14 is positioned at the other part of the housing 10 in the first direction. The first end portion 13 and the second end portion 14 are spaced apart from each other in the first direction. The first end portion 13 is an end portion that is the leading end during attachment of the developing cartridge 1 to the drum unit 2.

As illustrated in FIG. 7, an accommodating chamber 15 and a developing chamber 18 are provided in the housing 10. Toner is accommodated in the accommodating chamber 15. The housing 10 has an opening 16. The opening 16 is positioned at the first end portion 13. The developing chamber 18 is positioned between the accommodating chamber 15 and the opening 16 in the first direction. The accommodating chamber 15 is positioned between the second end portion 14 and the developing chamber 18 in the first direction. The developing roller 30 and the supply roller 40 are provided in the developing chamber 18. The outside of the housing 10 and the developing chamber 18 are in communication with each other through the opening 16. As illustrated in FIGS. 4 and 5, the housing 10 includes a handle 17. The handle 17 is positioned at the second end portion 14 of the housing 10.

### <3-2. Agitator>

The agitator 20 is a member for agitating toner in the housing 10. As illustrated in FIG. 7, the agitator 20 includes an agitator shaft 21 and an agitator blade 22. The agitator shaft 21 extends in the second direction in the housing 10. The agitator shaft 21 is rotatable about an agitator axis extending in the second direction. The agitator shaft 21 is supported by the housing 10. The agitator blade 22 expands outward in a radial direction of the agitator shaft 21 from the agitator shaft 21. When the agitator 20 rotates about the agitator axis, toner in the housing 10 is agitated by the agitator blade 22.

### <3-3 Developing Roller>

The developing roller 30 is a roller rotatable about a developing axis extending in the second direction. The developing roller 30 is positioned at the opening 16 of the housing 10. That is, the developing roller 30 is positioned at the one end portion of the housing 10 in the first direction. The developing roller 30 includes a developing roller body 31 and the developing shaft 32. The developing roller body 31 is a cylindrical member extending in the second direction. The developing roller body 31 is made of rubber having elasticity, for example. The developing shaft 32 is a columnar member extending in the second direction. The developing shaft 32 extends through the developing roller body 31. The developing roller body 31 is fixed to the developing shaft 32. The developing shaft 32 is made of metal or electrically conductive resin.

One end portion of the developing shaft 32 in the second direction is rotatably supported by the developing electrode 60. The other end portion of the developing shaft 32 in the second direction is mounted on a developing roller gear 56. The rotation of the developing roller gear 56 rotates both the developing roller body 31 and the developing shaft 32 about the developing axis. Toner in the housing 10 is carried onto the outer circumferential surface of the developing roller body 31.

In a state where each developing cartridge 1 is attached to the drum unit 2, the developing roller 30 is in contact with the corresponding photosensitive drum 91 in the first direction. Specifically, the outer circumferential surface of the developing roller 30 is in contact with the outer circumferential surface of the photosensitive drum 91 in the first direction. Hence, toner carried on the outer circumferential surface of the developing roller 30 is supplied to the photosensitive drum 91.

Each developing cartridge 1 includes a blade 33. The blade 33 is placed on the outer circumferential surface of the developing roller 30. Specifically, the blade 33 is in abutment on the developing roller 30 in the third direction. One end of the blade 33 is fixed to the housing 10. The other end of the blade 33 is in contact with the outer circumferential surface of the developing roller 30. In the third direction, the blade 33 is positioned opposite the first end portion 13 of the housing 10 with respect to the developing shaft 32. The blade 33 is configured to shape toner carried on the outer circumferential surface of the developing roller 30 so that the toner has a predetermined thickness.

### <3-4. Supply Roller>

The supply roller 40 is a roller rotatable about a supply axis extending in the second direction. The supply roller 40 is positioned inside the housing 10. Specifically, the supply roller 40 is positioned between the developing roller 30 and the agitator 20 in the first direction. The supply roller 40 includes a supply roller body 41 and a supply shaft 42. The supply roller body 41 is a cylindrical member extending in the second direction. The supply roller body 41 is made of rubber having elasticity, for example. The outer circumferential surface of the supply roller body 41 is in contact to the outer circumferential surface of the developing roller body 31 in the first direction. The supply shaft 42 is a columnar member extending in the second direction. The supply shaft 42 extends through the supply roller body 41. The supply roller body 41 is fixed to the supply shaft 42. The supply shaft 42 is made of metal or electrically conductive resin.

One end portion of the supply shaft 42 in the second direction is rotatably supported by the developing electrode 60. The other end portion of the supply shaft 42 in the second direction is mounted on a supply roller gear 54. The rotation of the supply roller gear 54 rotates the supply roller body 41 and the supply shaft 42 about the supply axis. The supply roller 40 supplies toner in the housing 10 to the developing roller 30.

### <3-5. Gear Section>

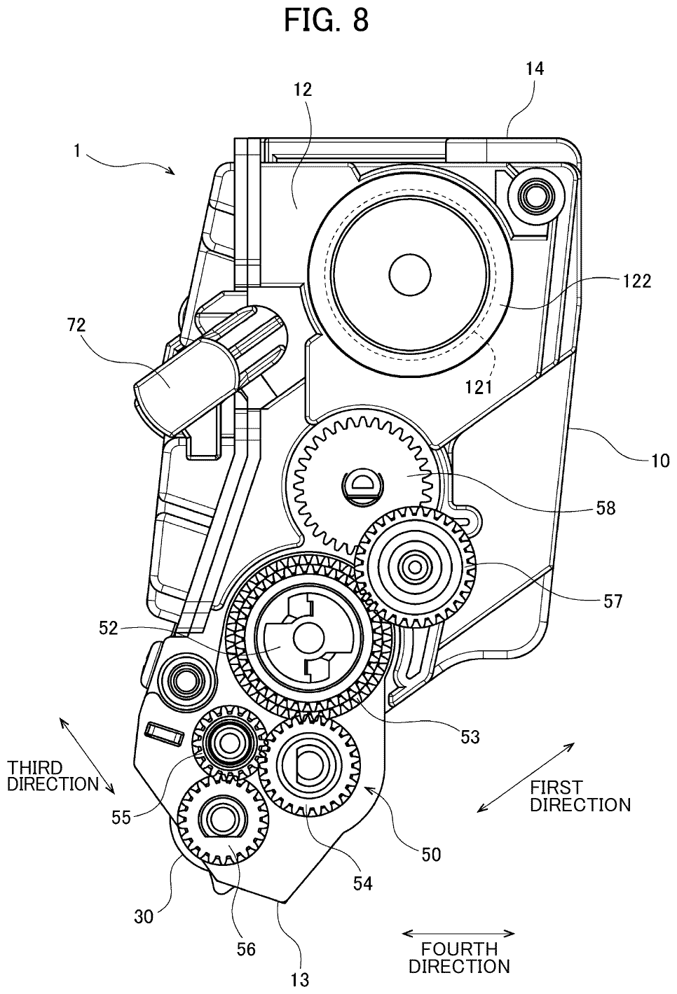

The gear section 50 is positioned at the second outer peripheral surface 12 of the housing 10. As illustrated in FIG. 4, the gear section 50 includes a gear cover 51. The gear cover 51 is mounted to the second outer peripheral surface 12 of the housing 10. FIG. 8 is a view illustrating the developing cartridge 1 with the gear cover 51 removed, when viewed in the second direction from the side where the second outer peripheral surface 12 is positioned.

As illustrated in FIG. 8, the gear section 50 includes a coupling 52, a coupling gear 53, the supply roller gear 54, a first idle gear 55, the developing roller gear 56, a second idle gear 57, and an agitator gear 58. Each of the coupling 52, the coupling gear 53, the supply roller gear 54, the first idle gear 55, the developing roller gear 56, the second idle gear 57, and the agitator gear 58 is rotatable about its own axis extending in the second direction.

The coupling gear 53, the supply roller gear 54, the first idle gear 55, the developing roller gear 56, the second idle gear 57, and the agitator gear 58 are positioned between the second outer peripheral surface 12 and the gear cover 51 in the second direction. That is, the coupling gear 53, the supply roller gear 54, the first idle gear 55, the developing roller gear 56, the second idle gear 57, and the agitator gear 58 are covered by the gear cover 51.

The coupling 52 is exposed through the gear cover 51. That is, the coupling 52 is visible from the outside of the housing 10 through the gear cover 51. When the drum unit 2 to which the developing cartridges 1 are attached is attached to the image forming apparatus 100, drive shafts of the image forming apparatus 100 are connected to the couplings 52. Then, the rotation of each drive shaft is transmitted to the corresponding coupling 52. As a result, the coupling gear 53 rotates together with the coupling 52.

The coupling gear 53 is in meshing engagement with the supply roller gear 54. The supply roller gear 54 is in meshing engagement with the first idle gear 55. The first idle gear 55 is in meshing engagement with the developing roller gear 56. Also, the coupling gear 53 is in meshing engagement with the second idle gear 57. The second idle gear 57 is in meshing engagement with the agitator gear 58.

The end portion of the supply shaft 42 in the second direction is connected to the supply roller gear 54. Specifically, the other end portion of the supply shaft 42 in the second direction is connected to the supply roller gear 54. Hence, when the coupling 52 rotates, the rotation of the coupling 52 is transmitted to the supply shaft 42 via the coupling gear 53 and the supply roller gear 54. Accordingly, the supply roller 40 rotates about the supply axis.

The end portion of the developing shaft 32 in the second direction is connected to the developing roller gear 56. Specifically, the other end portion of the developing shaft 32 in the second direction is connected to the developing roller gear 56. Hence, when the coupling 52 rotates, the rotation of the coupling 52 is transmitted to the developing shaft 32 via the coupling gear 53, the supply roller gear 54, the first idle gear 55, and the developing roller gear 56. Accordingly, the developing roller 30 rotates about the developing axis.

The end portion of the agitator shaft 21 in the second direction is connected to the agitator gear 58. Hence, when the coupling 52 rotates, the rotation of the coupling 52 is transmitted to the agitator shaft 21 via the coupling gear 53, the second idle gear 57, and the agitator gear 58. Accordingly, the agitator 20 rotates about the agitator axis. As a result, toner (developer) accommodated in the housing 10 is agitated.

As illustrated in FIG. 8, the housing 10 has a filling port 121 and a cap 122. The filling port 121 is positioned on the second outer peripheral surface 12 of the housing 10. The filling port 121 is a port formed on the second outer peripheral surface 12 of the housing 10. Toner is filled into the accommodating chamber 15 of the housing 10 through the filling port 121. The cap 122 is configured to seal the filling port 121.

### <3-6. Memory Assembly>

The memory assembly 80 is positioned at the first outer peripheral surface 11 of the housing 10. As illustrated in FIGS. 5 and 6, the memory assembly 80 includes a memory 81, a holder 82, and a holder cover 83.

The memory 81 is a storage medium storing therein information related to the developing cartridge 1. The memory 81 is an IC chip, for example. The memory 81 stores information related to the specifications of the developing cartridge 1 or information related to the life time of the developing cartridge 1, for example. The memory 81 has an electrical contact surface 811. The electrical contact surface 811 is electrically connected to the memory cells of the memory 81. The electrical contact surface 811 is positioned at one end portion of the holder 82 in the fourth direction. In the present embodiment, the memory 81 is held by the one end portion of the holder 82 in the fourth direction. However, of components of the memory 81, only the electrical contact surface 811 may be held by the holder 82, and the memory cells of the memory 81 may be held by part of the developing cartridge 1 other than the holder 82.

The holder cover 83 is mounted to the first outer peripheral surface 11 of the housing 10. At least part of the holder 82 is covered by the holder cover 83. The holder 82 is positioned between the first outer peripheral surface 11 of the housing 10 and the holder cover 83. The holder 82 is movable in the first direction, the second direction, the third direction, and the fourth direction relative to both the housing 10 and the holder cover 83. Accordingly, the electrical contact surface 811 of the memory 81 is movable in the first direction, the second direction, the third direction, and the fourth direction relative to both the housing 10 and the holder cover 83.

### <3-7. Developing Electrode>

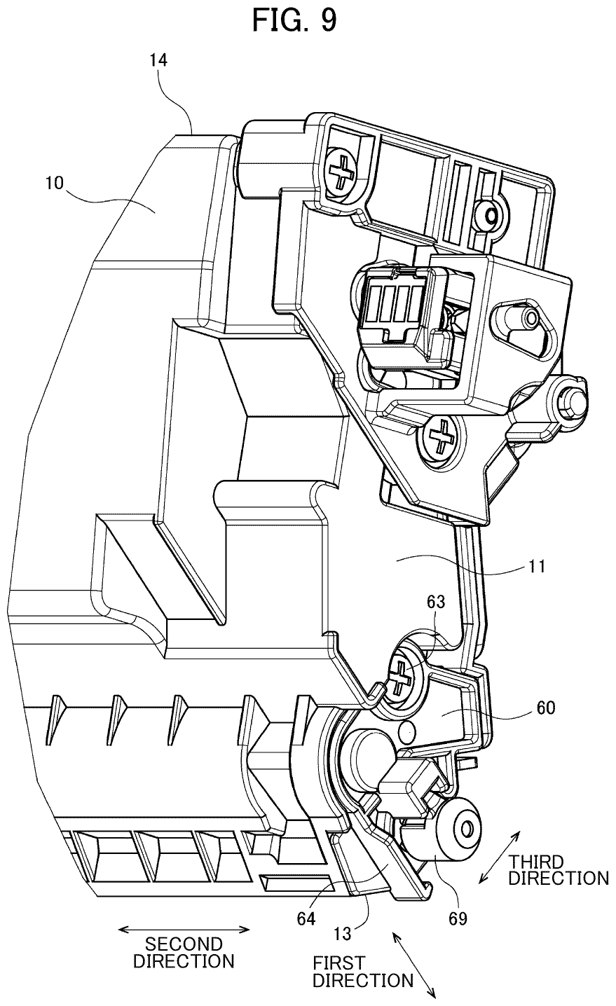

FIG. 9 is a partial perspective view of the developing cartridge 1 in the vicinity of the first outer peripheral surface 11. As illustrated in FIGS. 6 and 9, the developing electrode 60 is positioned on the first outer peripheral surface 11 of the housing 10. The developing electrode 60 is fixed to the first outer peripheral surface 11 of the housing 10 with a screw 63. The developing electrode 60 is an electrically conductive member. Specifically, the developing electrode 60 is made of electrically conductive resin.

As illustrated by the dashed-line in FIG. 6, the developing electrode 60 has the first bearing hole 61. The first bearing hole 61 is a through hole having a circular shape. The first bearing hole 61 extends through the developing electrode 60 in the second direction along the developing axis. The one end portion of the developing shaft 32 in the second direction is inserted into the first bearing hole 61. Accordingly, the developing shaft 32 is supported by the developing electrode 60 so as to be rotatable about the developing axis.

The one end portion of the developing shaft 32 in the second direction is in contact with the inner circumferential surface of the first bearing hole 61. Accordingly, the developing shaft 32 and the developing electrode 60 are electrically connected to each other. That is, the inner circumferential surface of the first bearing hole 61 functions as a connection portion electrically connected to the one end portion of the developing shaft 32 in the second direction.

Each developing cartridge 1 includes a collar 69. The collar 69 is mounted to the one end portion of the developing shaft 32 in the second direction. The collar 69 is a separate member from the developing electrode 60. The collar 69 is positioned further outward than the first bearing hole 61 in the second direction. The collar 69 is detachable from the developing electrode 60. In other words, the collar 69 is detachably attached to the developing electrode 60. The collar 69 is supported so as to be rotatable about the developing axis relative to the developing electrode 60.

The collar 69 is a non-electrically conductive member. Specifically, the collar 69 is made of non-electrically conductive resin. Generally, non-electrically conductive resin has a rigidity greater than the rigidity of the electrically conductive resin. Hence, the use of a non-electrically conductive resin for the collar 69 can reduce the likelihood of cracking of the collar 69, compared to a case where an electrically conductive resin is used for the collar 69.

As illustrated by the dashed-line in FIG. 6, the developing electrode 60 has a second bearing hole 62. The second bearing hole 62 is a through hole having a circular shape. The second bearing hole 62 extends through the developing electrode 60 in the second direction along the supply axis. The one end portion of the supply shaft 42 in the second direction is inserted into the second bearing hole 62. Hence, the supply shaft 42 is supported by the developing electrode 60 so as to be rotatable about the supply axis.

Also, the one end portion of the supply shaft 42 in the second direction is in contact with the inner circumferential surface of the second bearing hole 62. Hence, the supply shaft 42 and the developing electrode 60 are electrically connected to each other.

The first bearing hole 61 and the second bearing hole 62 are spaced apart from each other in the first direction. The first bearing hole 61 is positioned closer to the first end portion 13 of the housing 10 in the first direction than the second bearing hole 62 is to the first end portion 13 in the first direction.

As illustrated in FIGS. 6 and 9, the developing electrode 60 has the contact surface 64. The contact surface 64 is a surface in contact with the corresponding drum electrode 93 of the drum unit 2 in a state where the developing cartridge 1 is attached to the drum unit 2. The contact surface 64 is positioned at the one end portion of the housing 10 in the second direction. The first bearing hole 61, the second bearing hole 62, and the contact surface 64 are formed as a single piece using an electrically conductive resin. Hence, the inner circumferential surface of the first bearing hole 61 and the contact surface 64 are electrically connected to each other. Also, the inner circumferential surface of the second bearing hole 62 and the contact surface 64 are electrically connected to each other.

The contact surface 64 is spaced apart from the first bearing hole 61 in the third direction. Specifically, the contact surface 64 is positioned opposite the blade 33 with respect to the developing shaft 32. In other words, the contact surface 64 is positioned further from the blade 33 in the third direction than the developing roller 30 is from the blade 33 in the third direction. That is, the developing shaft 32 is positioned between the blade 33 and the contact surface 64 in the third direction. The distance between the contact surface 64 and the blade 33 is greater than the distance between the contact surface 64 and the developing shaft 32.

The contact surface 64 is spaced apart from the first bearing hole 61 in a vertical direction, which is orthogonal to both the second direction and the fourth direction. Specifically, the contact surface 64 is positioned opposite the blade 33 with respect to the developing shaft 32 in the vertical direction. In other words, the contact surface 64 is positioned further from the blade 33 in the vertical direction than the developing roller 30 is from the blade 33 in the vertical direction. That is, the developing shaft 32 is positioned between the blade 33 and the contact surface 64 in the vertical direction. The contact surface 64 is positioned further downward than the developing shaft 32. The blade 33 is positioned further upward than the developing shaft 32.

The contact surface 64 is spaced apart from the accommodating chamber 15 in the third direction. Specifically, the contact surface 64 is positioned opposite the accommodating chamber 15 with respect to the developing shaft 32 in the third direction. In other words, the contact surface 64 is positioned further from the accommodating chamber 15 in the third direction than the developing roller 30 is from the accommodating chamber 15 in the third direction. That is, the developing shaft 32 is positioned between the accommodating chamber 15 and the contact surface 64 in the third direction. The distance between the contact surface 64 and the accommodating chamber 15 is greater than the distance between the contact surface 64 and the developing shaft 32.

The contact surface 64 is spaced apart from the accommodating chamber 15 in the vertical direction, which is orthogonal to both the second direction and the fourth direction. Specifically, the contact surface 64 is positioned opposite the accommodating chamber 15 with respect to the developing shaft 32 in the vertical direction. In other words, the contact surface 64 is positioned further from the accommodating chamber 15 in the vertical direction than the developing roller 30 is from the accommodating chamber 15 in the vertical direction. That is, the developing shaft 32 is positioned between the accommodating chamber 15 and the contact surface 64 in the vertical direction. The contact surface 64 is positioned further downward than the developing shaft 32. The accommodating chamber 15 is positioned further upward than the developing shaft 32.

The contact surface 64 is spaced apart from the agitator 20 in the third direction. Specifically, the contact surface 64 is positioned opposite the agitator 20 with respect to the developing shaft 32 in the third direction. In other words, the contact surface 64 is positioned further from the agitator 20 in the third direction than the developing roller 30 is from the agitator 20 in the third direction. That is, the developing shaft 32 is positioned between the agitator 20 and the contact surface 64 in the third direction. The distance between the contact surface 64 and the agitator 20 is greater than the distance between the contact surface 64 and the developing shaft 32.

The contact surface 64 is spaced apart from the agitator 20 in the vertical direction, which is orthogonal to both the second direction and the fourth direction. Specifically, the contact surface 64 is positioned opposite the agitator 20 with respect to the developing shaft 32 in the vertical direction. In other words, the contact surface 64 is positioned further from the agitator 20 in the vertical direction than the developing roller 30 is from the agitator 20 in the vertical direction. That is, the developing shaft 32 is positioned between the agitator 20 and the contact surface 64 in the vertical direction. The contact surface 64 is positioned further downward than the developing shaft 32. The agitator 20 is positioned further upward than the developing shaft 32.

The contact surface 64 extends in the first direction and the second direction. That is, the contact surface 64 is a flat surface extending both in the first direction and in the second direction. The length of the contact surface 64 in the first direction is longer than the length of the contact surface 64 in the second direction. The contact surface 64 faces in the third direction. Specifically, the contact surface 64 faces in a direction away from the developing shaft 32 in the third direction.

The contact surface 64 is positioned closer to the developing shaft 32 than the screw 63 is to the developing shaft 32. The screw 63 is for fixing the developing electrode 60 to the housing 10. In other words, the distance between the developing shaft 32 and the contact surface 64 is smaller than the distance between the developing shaft 32 and the screw 63. Also, the contact surface 64 is positioned closer to the first bearing hole 61 than the second bearing hole 62 is to the first bearing hole 61. In other words, the distance between the first bearing hole 61 and the contact surface 64 is smaller than the distance between the first bearing hole 61 and the second bearing hole 62. In a state where the drum unit 2 to which each developing cartridge 1 is attached is attached to the image forming apparatus 100, the contact surface 64 is positioned further downward than the second bearing hole 62. Also, in a state where the drum unit 2 to which each developing cartridge 1 is attached is attached to the image forming apparatus 100, at least part of the contact surface 64 is positioned further downward than the developing shaft 32.

The contact surface 64 is spaced apart from the screw 63 in the third direction. Specifically, the contact surface 64 is positioned opposite the screw 63 with respect to the developing shaft 32 in the third direction. In other words, the contact surface 64 is positioned further from the screw 63 in the third direction than the developing shaft 32 is from the screw 63 in the third direction. That is, the developing shaft 32 is positioned between the screw 63 and the contact surface 64 in the third direction.

The contact surface 64 is positioned opposite the screw 63 with respect to the second bearing hole 62 in the third direction. In other words, the contact surface 64 is positioned further from the screw 63 in the third direction than the second bearing hole 62 is from the screw 63 in the third direction. That is, the second bearing hole 62 is positioned between the screw 63 and the contact surface 64 in the third direction.

The collar 69 has one end portion in the second direction which is positioned outermost in the second direction. In the second direction, the contact surface 64 is positioned closer to the other end portion of the developing shaft 32 in the second direction than the one end portion of the collar 69 in the second direction is to the other end portion of the developing shaft 32 in the second direction. The range in which the contact surface 64 lies in the second direction, and the range in which the collar 69 lies in the second direction overlap at least partially. Part of the contact surface 64 and part of the collar 69 overlap each other in the third direction (i.e., when viewed in the third direction). The projection of the contact surface 64 on a virtual plane and the collar 69 overlap at least partially. The virtual plane extends both in the first direction and in the second direction, and passes through the developing axis.

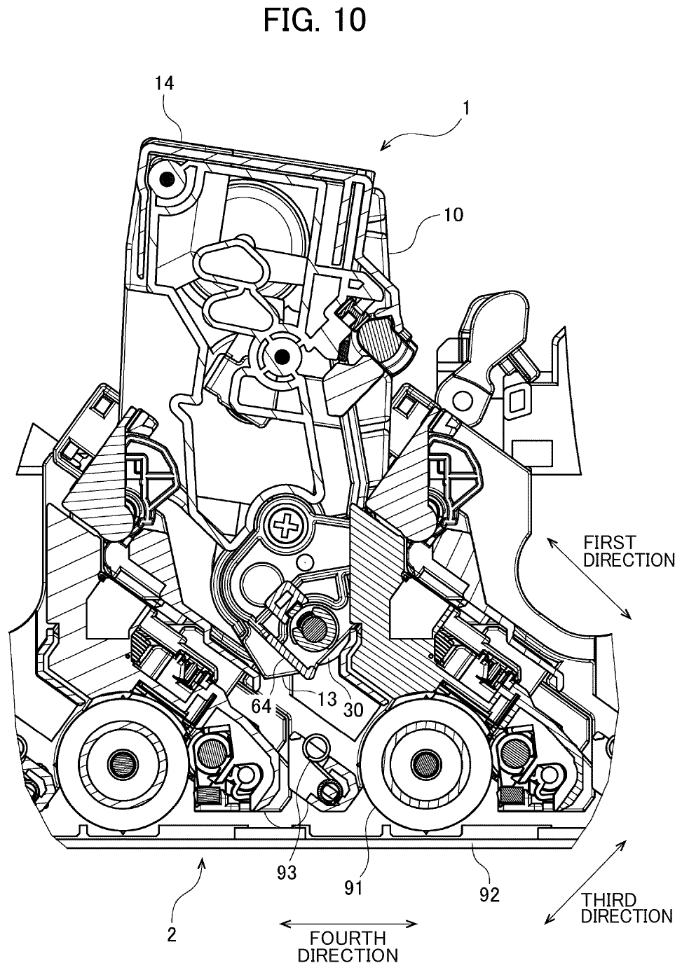

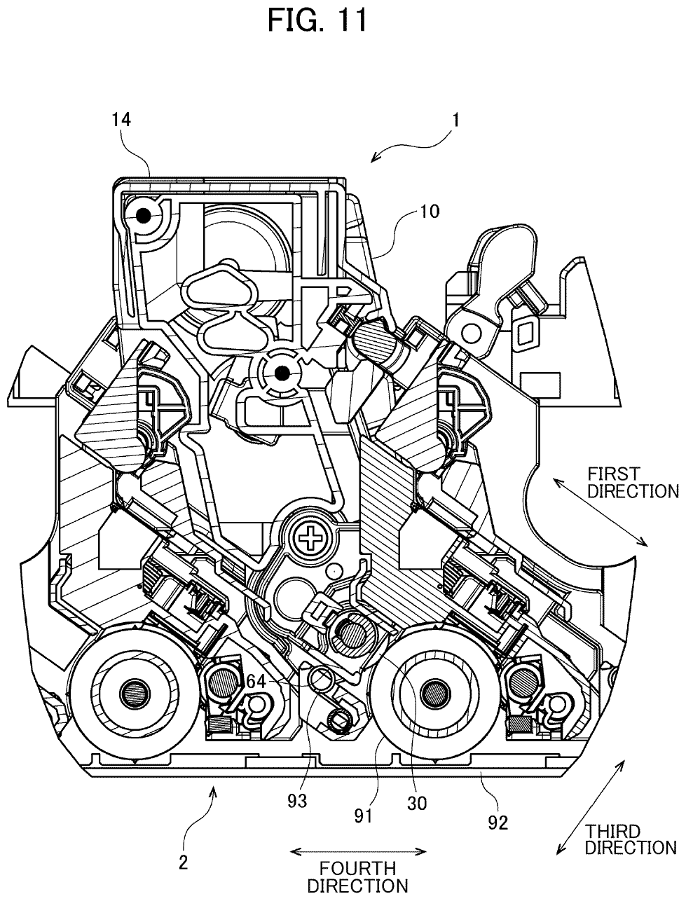

FIG. 10 is a cross-sectional view illustrating the intermediate stage of the attachment of the developing cartridge 1 to the drum unit 2. FIG. 11 is a cross-sectional view illustrating a state where the attachment of the developing cartridge 1 to the drum unit 2 is completed. Each of FIGS. 10 and 11 illustrates a cross section that has the contact surface 64 and is orthogonal to the second direction.

As illustrated in FIG. 10, each developing cartridge 1 is configured to be attached to the drum frame 92 with the first end portion 13 of the housing 10 at the leading end of the developing cartridge 1. After the attachment of the developing cartridge 1 to the drum frame 92 is completed, the contact surface 64 is in contact with the corresponding drum electrode 93 in the third direction as illustrated in FIG. 11. The drum electrode 93 is a spring configured to expand and contract in the third direction. The drum electrode 93 is a coil spring, for example. In the present embodiment, torsion coil springs are employed as the drum electrode 93. When the contact surface 64 contacts the drum electrode 93, the drum electrode 93 is elastically deformed in the third direction and applies an elastic force to the contact surface 64 to press the contact surface 64 in the third direction. Accordingly, the drum electrode 93 is in tight contact with the contact surface 64. As a result, the drum electrode 93 and the developing electrode 60 are electrically connected to each other.

After the drum unit 2 to which the developing cartridge 1 is attached is attached to the image forming apparatus 100, the image forming apparatus 100 can supply voltage to both the developing shaft 32 and the supply shaft 42 via both the corresponding drum electrode 93 and the corresponding developing electrode 60. Toner is carried onto the outer circumferential surface of the supply roller 40 due to an electrostatic force generated by the voltage supplied to the supply shaft 42. Also, toner is carried onto the outer circumferential surface of the developing roller 30 due to an electrostatic force generated by the voltage supplied to the developing shaft 32.

As illustrated in FIG. 10, during attachment of the developing cartridge 1 to the drum unit 2, the contact surface 64 is positioned at the leading end of the developing cartridge 1. Specifically, the contact surface 64 is positioned closer to the first end portion 13 than the developing shaft 32 is to the first end portion 13. In other words, the length between the contact surface 64 and the first end portion 13 is smaller than the length between the developing shaft 32 and the first end portion 13. With this configuration, during attachment of the developing cartridge 1 to the drum unit 2, a state where the contact surface 64 is positioned closer to the drum electrode 93 than the other parts of the developing cartridge 1 are to the drum electrode 93 can be maintained. Accordingly, the likelihood of the drum electrode 93 contacting the other parts of the developing cartridge 1 other than the contact surface 64 can be reduced. As a result, the other parts of the developing cartridge 1 other than the contact surface 64 can be designed without concerning interference with the drum electrode 93.

For example, in a process where the developing cartridge 1 is attached to the drum unit 2, the collar 69 does not contact the drum electrode 93. Accordingly, the collar 69 can be extended further outward than the developing electrode 60 in the second direction.

In the present embodiment, the drum electrode 93 is configured to press the contact surface 64 in the third direction. As a result, the dimension of the drum electrode 93 in the second direction can be shorter in comparison to a case where the drum electrode 93 is configured to press the contact surface 64 in the second direction.

As illustrated in FIG. 11, in a state where the developing cartridge 1 is attached to the drum unit 2, the drum electrodes 93 presses the contact surface 64 toward the developing shaft 32. Accordingly, due to the pressing force received by the contact surface 64 from the drum electrode 93, torque centered on the developing shaft 32 is less likely to be applied to the developing cartridge developing cartridge 1. As a result, the orientation of the developing cartridge 1 can be more stable in comparison to a case where the drum electrode 93 presses the contact surface 64 in a direction other than the direction in which the drum electrode 93 presses the contact surface 64 toward the developing shaft 32.

### <3-8. Separation Member>

In a state where the drum unit 2 to which the four developing cartridges 1 are attached is attached to the image forming apparatus 100, a separation operation can be performed on each developing cartridge 1 in the image forming apparatus 100. The separation operation is an operation in which the developing roller 30 is moved from a contacting position to a separated position relative to the photosensitive drum 91. At the contacting position, the developing roller 30 is in contact with the photosensitive drum 91. At the separated position, the developing roller 30 is separated from the photosensitive drum 91. Of the four developing cartridges 1, the separation operation is performed on each of the developing cartridges 1 which corresponds to colors of toner which are not used for forming an image in the image forming apparatus 100. Accordingly, the developing roller 30 of each developing cartridge 1 which is not used is in a separated state where the developing roller 30 of the developing cartridge 1 is separated from the photosensitive drum 91.

The separation member 70 is a member for moving the developing roller 30 between the contacting position and the separated position. That is, the separation member 70 switches the developing roller 30 from a state where the developing roller 30 is at the contacting position to a state where the developing roller 30 is at the separated position. The separation member 70 is positioned between the first end portion 13 and the second end portion 14 of the housing 10 in the first direction.

As illustrated in FIG. 4, the separation member 70 includes a first cam 71, a second cam 72, and a separation shaft 73. The separation member 70 is made of resin, for example. Specifically, the first cam 71, the second cam 72, and the separation shaft 73 are formed as a single piece using resin. However, the first cam 71, the second cam 72, and the separation shaft 73 may be individual members separated from each other. In this case, only the first cam 71 and the second cam 72 are made of resin, and the separation shaft 73 may be made of metal.

As illustrated in FIG. 4, each developing cartridge 1 has a first through hole 191, a second through hole 192, and a guide recess 193. The guide recess 193 is positioned at the outer peripheral surface of the housing 10. The first through hole 191 is positioned at one end portion of the developing cartridge 1 in the second direction. The first through hole 191 is a hole extending in the second direction. The second through hole 192 is positioned at the other end portion of the developing cartridge 1 in the second direction. The second through hole 192 is a hole extending in the second direction. The guide recess 193 is positioned between the first through hole 191 and the second through hole 192 in the second direction. The guide recess 193 extends in the second direction on the outer peripheral surface of the housing 10.

The separation shaft 73 is disposed in the guide recess 193. The separation shaft 73 extends in the second direction along the guide recess 193. One end portion of the separation shaft 73 in the second direction is inserted into the first through hole 191. Hence, the one end portion of the separation shaft 73 in the second direction is supported by the housing 10. The other end portion of the separation shaft 73 in the second direction is inserted into the second through hole 192. Hence, the other end portion of the separation shaft 73 in the second direction is supported by the housing 10.

The first cam 71 is positioned at the one end portion of the separation member 70 in the second direction. The first cam 71 is positioned at the first outer peripheral surface 11 of the housing 10. The first cam 71 has a first sloped surface 711. The first sloped surface 711 is part of the circumferential surface centered on the separation shaft 73. The first sloped surface 711 is part of the circumferential surface of the first cam 71, which is centered on the separation shaft 73. The first sloped surface 711 is sloped relative to the second direction. Specifically, the first sloped surface 711 is sloped such that the first sloped surface 711 is closer to the developing roller 30 in the first direction as the first sloped surface 711 extends toward the other end portion of the separation member 70 in the second direction.

The second cam 72 is positioned at the other end portion of the separation member 70 in the second direction. The second cam 72 is positioned at the second outer peripheral surface 12 of the housing 10. The second cam 72 has a second sloped surface 721. The second sloped surface 721 is part of a circumferential surface centered on the separation shaft 73. The second sloped surface 721 is part of the circumferential surface of the second cam 72, which is centered on the separation shaft 73. The second sloped surface 721 is sloped relative to the second direction. Specifically, the second sloped surface 721 is sloped such that the second sloped surface 721 is closer to the developing roller 30 in the first direction as the second sloped surface 721 extends toward the other end portion of the separation member 70 in the second direction.

The separation member 70 is movable between a first position and a second position in the second direction relative to the housing 10 and the developing roller 30. The second position is a position closer to the side where the one end part of the separation member 70 is positioned than the first position is to the side. In other words, the second position is a position closer to the first outer peripheral surface 11 of the housing 10 than the first position is to the first outer peripheral surface 11. That is, the movement of the separation member 70 from the first position to the second position is equivalent to the movement of the separation member 70 in a direction from the second cam 72 toward the first cam 71.

The image forming apparatus 100 includes an urging member (not illustrated) for urging the separation member 70. The urging member is a spring configured to expand and contract in the second direction. The urging member is disposed between the second outer peripheral surface 12 of the housing 10 and the second cam 72. Specifically, the urging member which is in a contracted state where the urging member contracts in the second direction relative to its natural length is disposed between the second outer peripheral surface 12 of the housing 10 and the second cam 72. Accordingly, the separation member 70 is urged toward the first position from the second position by the elastic force of the urging member. As a result, the separation member 70 is disposed at the first position in a state where the separation member 70 does not receive any external force.

In a state where the drum unit 2 to which the four developing cartridge 1 are attached to the image forming apparatus 100, and when the separating operation is performed in the image forming apparatus 100, the second cam 72 is pressed toward the first cam 71 in the second direction. Accordingly, the separation member 70 moves from the first position to the second position relative to the housing 10 due to the contraction of the urging member.

In a process where the separation member 70 moves from the first position to the second position, the first sloped surface 711 of the first cam 71 moves in the second direction while the first sloped surface 711 is in contact with the drum frame 92. At this time, since the first cam 71 receives the reaction force from the drum frame 92, the first cam 71 moves in the first direction relative to the drum unit 2. Specifically, the first cam 71 moves relative to the drum unit 2 in a direction away from the photosensitive drum 91 due to the reaction force received from the drum frame 92.

Similarly, in a process where the separation member 70 moves from the first position to the second position, the second sloped surface 721 of the second cam 72 moves in the second direction while the second sloped surface 721 is in contact with the drum frame 92. At this time, since the second cam 72 receives the reaction force from the drum frame 92, the second cam 72 moves in the first direction relative to the drum unit 2. Specifically, the second cam 72 moves relative to the drum unit 2 in the direction away from the photosensitive drum 91 due to the reaction force received from the drum frame 92.

Accordingly, the housing 10 and the developing roller 30 move in the first direction relative to the drum unit 2 together with the separation member 70. Specifically, the housing 10 and the developing roller 30 move in the direction away from the photosensitive drum 91 relative to the drum unit 2. As a result, the developing roller 30 moves in the first direction from the contacting position at which the developing roller 30 is in contact with the photosensitive drum 91 to the separated position at which the developing roller 30 is separated from the photosensitive drum 91.

The drum electrodes 93 is in contact with the contact surface 64 of the developing electrode 60 in both a state where the developing roller 30 is disposed at the contacting position and a state where the developing roller 30 is disposed at the separated position. That is, a state where the drum electrodes 93 is in contact with the contact surface 64 of the developing electrode 60 is maintained during the movement of the developing roller 30 from the contacting position to the separated position. At this time, the contact surface 64 moves in the first direction relative to the drum electrodes 93. Since the contact surface 64 is a surface extending in the first direction, the contact surface 64 can move smoothly in the first direction relative to the drum electrodes 93 and a state where the drum electrodes 93 is in contact with the contact surface 64 of the developing electrode 60 can be maintained.

### <4. Variations>

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiment of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

### <4-1. First Variation>

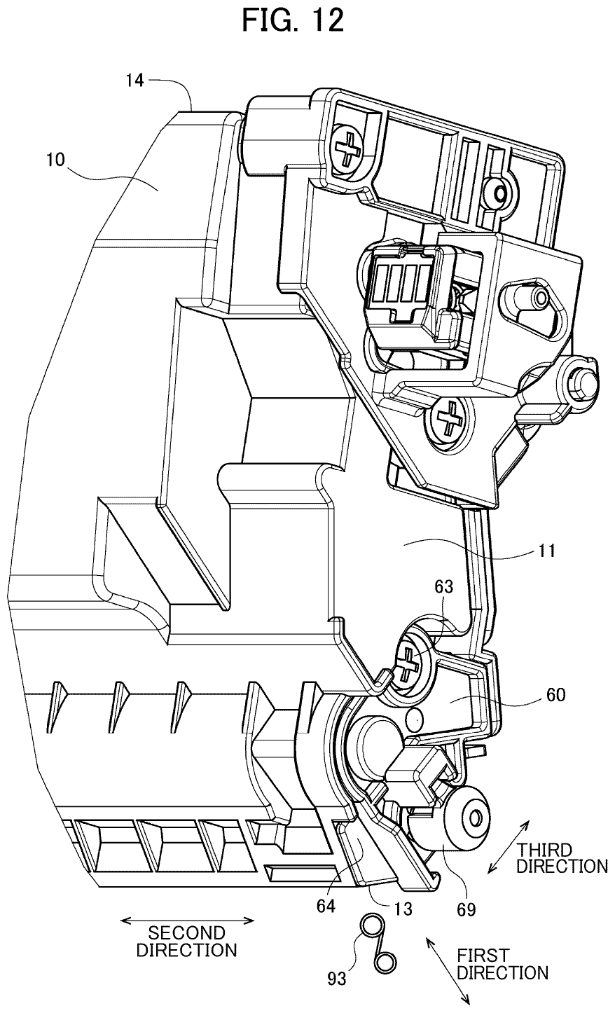

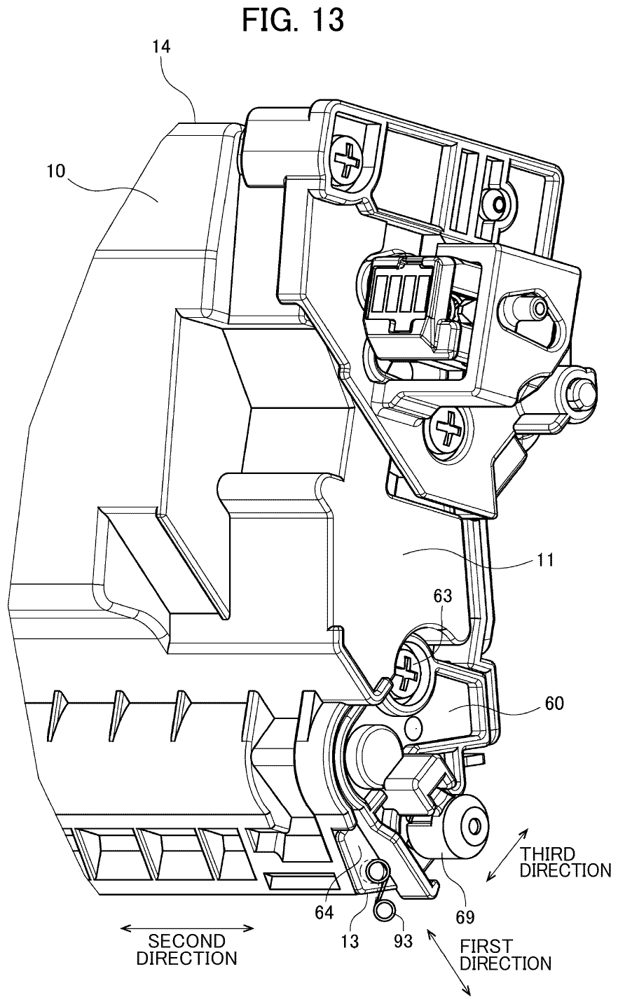

FIGS. 12 and 13 is a partial perspective view of the developing cartridge 1 and the drum electrode 93 according to the first variation. FIG. 12 illustrates the intermediate stage of the attachment of the developing cartridge 1 to the drum unit 2. FIG. 13 illustrates a state where the attachment of the developing cartridge 1 to the drum unit 2 is completed. In FIGS. 12 and 13, of the drum unit 2, the other parts other than the drum electrode 93 is omitted.

In FIGS. 12 and 13, the developing electrode 60 includes the contact surface 64. Similar to the embodiment described above, the contact surface 64 is apart from the first bearing hole 61 in the third direction. However, the contact surface 64 illustrated in FIGS. 12 and 13 is a surface crossing the second direction. That is, the contact surface 64 expands in the first direction and the third direction. The contact surface 64 faces in the second direction. Specifically, the contact surface 64 faces in a direction away from the housing 10 in the second direction.

In the FIGS. 12 and 13, the drum electrode 93 is a spring configured to expand and contract in the second direction. The drum electrode 93 is a coil spring, for example. In the present variation, a helical torsion spring is employed as the drum electrode 93. When the developing cartridge 1 is attached to the drum frame 92, the contact surface 64 comes into contact with the drum electrode 93 in the second direction as illustrated in FIG. 13. At this time, the drum electrode 93 is bent in the second direction and presses the contact surface 64 in the second direction with the elastic force of the drum electrode 93. Accordingly, the drum electrode 93 is closely pressed against the contact surface 64. As a result, the drum electrode 93 and the developing electrode 60 are electrically connected each other.

In the first variation, the contact surface 64 is positioned at the leading head of the developing cartridge 1 in a process where the developing cartridge 1 is attached to the drum unit 2. Specifically, the contact surface 64 is positioned closer to the first end portion 13 of the housing 10 than the developing shaft 32 is to the first end portion 13 of the housing 10. With this configuration, the drum electrode 93 is restricted from contacting the other parts than the contact surface 64 of the developing cartridge 1 in a process where the developing cartridge 1 is attached to the drum unit 2.

### <4-2. Other Variations>

In the embodiment described above, the four developing cartridge 1 are attachable to the drum unit 2. However, the number of the developing cartridge 1 attachable to the drum unit 2 may be one through three or five or more.

In the embodiment described above, the developing electrode 60 and the collar 69 are members separated from each other. However, the developing electrode 60 and the collar 69 may be formed into a single piece. For example, the developing electrode 60 and the collar 69 may be formed into a single piece using electrically conductive resin.

In the embodiment described above, the collar 69 is rotatable relative to the developing electrode 60. However, the collar 69 may be fixed to the developing electrode 60, and may be configured not to rotate. In the embodiment described above, the collar 69 is made of non-electrically conductive resin. However, the collar 69 may be made of electrically conductive resin. Voltage may be supplied to the developing shaft 32 via the electrically conductive collar 69.

The developing electrode 60 may be composed of two members in which one member has the first bearing hole 61 and the second bearing hole 62, and the other member has the contact surface 64. Also, the developing electrode 60 may be composed of three or more members.

In the embodiment described above, the helical torsion spring is employed as the drum electrode 93. However, other springs including a compression spring and a leaf spring may be employed as the drum electrode 93. Also, a spring, which is not made of metal, but is made of electrically conductive resin, may be employed as the drum electrode 93.

In the embodiment described above, the developing cartridge 1 is attached to the main frame 101 of the image forming apparatus 100 while attached to the drum unit 2. However, the developing cartridge 1 may be directly attached to the main frame 101 of the image forming apparatus 100.

Each element described above in the embodiment and variations may be appropriately combined or partially omitted to the extent that they are not contradictory.

What is claimed is:

1. A developing cartridge comprising:
a housing configured to accommodate toner, the housing having one end portion and an other end portion in a first direction, the other end portion being apart from the one end portion in the first direction;
a developing roller including a developing shaft extending in a second direction, the developing roller being positioned at the one end portion;
a blade placed on an outer circumferential surface of the developing roller; and
a developing electrode including:
a connection portion electrically connected to one end portion of the developing shaft in the second direction;
a contact surface positioned apart from the connection portion in a third direction crossing both the first direction and the second direction, the contact surface being electrically connected to the connection portion, the contact surface being positioned opposite the blade with respect to the developing shaft in the third direction, the contact surface extending in the first direction.

2. A developing cartridge comprising:
a housing configured to accommodate toner, the housing having one end portion and an other end portion in a first direction, the other end portion being apart from the one end portion in the first direction;
a developing roller including a developing shaft extending in a second direction, the developing roller being positioned at the one end portion;
a blade placed on an outer circumferential surface of the developing roller; and
a developing electrode including:
a connection portion electrically connected to an end portion of the developing shaft in the second direction;
a contact surface positioned apart from the connection portion in a third direction crossing both the first direction and the second direction, the contact surface being electrically connected to the connection portion, the contact surface being positioned further from the blade in the third direction than the developing roller is from the blade in the third direction, the contact surface extending in the first direction.

3. A developing cartridge comprising:
a housing configured to accommodate toner, the housing having one end portion and an other end portion in a first direction, the other end portion being apart from the one end portion in the first direction;
a developing roller including a developing shaft extending in a second direction, the developing roller being positioned at the one end portion;
a blade placed on an outer circumferential surface of the developing roller; and
a developing electrode including:
a connection portion electrically connected to an end portion of the developing shaft in the second direction; and
a contact surface positioned apart from the connection portion in a third direction crossing both the first direction and the second direction, the contact surface being electrically connected to the connection portion, the contact surface extending in the first direction,
wherein the developing shaft is positioned between the blade and the contact surface in the third direction.

4. A developing cartridge comprising:
a housing including an accommodating chamber in the housing, the accommodating chamber being configured to accommodate toner, the housing having one end portion and an other end portion in a first direction, the other end portion being apart from the one end portion in the first direction;
a developing roller including a developing shaft extending in a second direction, the developing roller being positioned at the one end portion; and
a developing electrode including:
a connection portion electrically connected to an end portion of the developing shaft in the second direction; and
a contact surface positioned apart from the connection portion in a third direction crossing both the first direction and the second direction, the contact surface being electrically connected to the connection portion, the contact surface being positioned opposite the accommodating chamber with respect to the developing shaft in the third direction, the contact surface extending in the first direction.

5. A developing cartridge comprising:
a housing including an accommodating chamber in the housing, the accommodating chamber being configured to accommodate toner, the housing having one end portion and an other end portion in a first direction, the other end portion being apart from the one end portion in the first direction;
a developing roller including a developing shaft extending in a second direction, the developing roller being positioned at the one end portion; and
a developing electrode including:
a connection portion electrically connected to an end portion of the developing shaft in the second direction; and
a contact surface positioned apart from the connection portion in a third direction crossing both the first direction and the second direction, the contact surface being electrically connected to the connection portion, the contact surface being positioned further from the accommodating chamber in the third direction than the developing roller is from the accommodating chamber in the third direction, the contact surface extending in the first direction.

6. A developing cartridge comprising:
a housing including an accommodating chamber in the housing, the accommodating chamber being configured to accommodate toner, the housing having one end portion and an other end portion in a first direction, the other end portion being apart from the one end portion in the first direction;
a developing roller including a developing shaft extending in a second direction, the developing roller being positioned at the one end portion; and
a developing electrode including:
a connection portion electrically connected to an end portion of the developing shaft in the second direction; and
a contact surface positioned apart from the connection portion in a third direction crossing both the first direction and the second direction, the contact surface being electrically connected to the connection portion, the contact surface extending in the first direction,
wherein the developing shaft is positioned between the accommodating chamber and the contact surface in the third direction.

7. A developing cartridge comprising:
a housing configured to accommodate toner, the housing having one end portion and an other end portion in a first direction, the other end portion being apart from the one end portion in the first direction;
an agitator configured to agitate toner in the housing;
a developing roller including a developing shaft extending in a second direction, the developing roller being positioned at the one end portion; and
a developing electrode including:
a connection portion electrically connected to an end portion of the developing shaft in the second direction; and
a contact surface positioned apart from the connection portion in a third direction crossing both the first direction and the second direction, the contact surface being electrically connected to the connection portion, the contact surface being positioned opposite the agitator with respect to the developing shaft in the third direction, the contact surface extending in the first direction.

8. A developing cartridge comprising:
a housing configured to accommodate toner, the housing having one end portion and an other end portion in a first direction, the other end portion being apart from the one end portion in the first direction;
an agitator configured to agitate toner in the housing;
a developing roller including a developing shaft extending in a second direction, the developing roller being positioned at the one end portion; and
a developing electrode including:
a connection portion electrically connected to an end portion of the developing shaft in the second direction; and
a contact surface positioned apart from the connection portion in a third direction crossing both the first direction and the second direction, the contact surface being electrically connected to the connection portion, the contact surface being positioned further from the agitator than the developing roller is from the agitator, the contact surface extending in the first direction.

9. A developing cartridge comprising:
a housing configured to accommodate toner, the housing having one end portion and an other end portion in a first direction, the other end portion being apart from the one end portion in the first direction;
an agitator configured to agitate toner in the housing;
a developing roller including a developing shaft extending in a second direction, the developing roller being positioned at the one end portion; and
a developing electrode including:
a connection portion electrically connected to an end portion of the developing shaft in the second direction; and
a contact surface positioned apart from the connection portion in a third direction crossing both the first direction and the second direction, the contact surface being electrically connected to the connection portion, the contact surface extending in the first direction,
wherein the developing shaft is positioned between the agitator and the contact surface in the third direction.

10. The developing cartridge according to claim 1,
wherein the developing electrode has a first bearing hole into which the one end portion of the developing shaft in the second direction is inserted.

11. The developing cartridge according to claim 10,
wherein the connection portion is an inner circumferential surface of the first bearing hole, the inner circumferential surface of the first bearing hole being in contact with the one end portion of the developing shaft in the second direction.

12. The developing cartridge according to claim 10, further comprising:
a supply roller including a supply shaft extending in the second direction, the supply roller being in contact with the developing roller in the first direction,
wherein the developing electrode has a second bearing hole into which one end portion of the supply shaft in the second direction is inserted.

13. The developing cartridge according to claim 12,
wherein the developing electrode is electrically connected to the one end portion of the supply shaft in the second direction.

14. The developing cartridge according to claim 12,
wherein the contact surface is positioned closer to the first bearing hole than the second bearing hole is to the first bearing hole.

15. The developing cartridge according to claim 1, further comprising:
a collar mounted on the one end portion of the developing shaft in the second direction,
wherein, in the second direction, the contact surface is positioned closer to an other end portion of the developing shaft in the second direction than one end portion of the collar in the second direction is to the other end portion of the developing shaft in the second direction.

16. The developing cartridge according to claim 15,
wherein the collar is non-electrically conductive.

17. The developing cartridge according to claim 16,
wherein the collar is made of non-electrically conductive resin, and
wherein the developing electrode is made of electrically conductive resin.

18. The developing cartridge according to claim 15,
wherein the developing electrode rotatably supports the collar.

19. The developing cartridge according to claim 15,
wherein the collar is detachably attached to the developing electrode.

20. The developing cartridge according to claim 15,
wherein at least a part of a range in the second direction in which the contact surface lies and at least a part of a range in the second direction in which the collar lies overlap each other.

21. The developing cartridge according to claim 1,
wherein the contact surface extends in both the first direction and the second direction.

22. The developing cartridge according to claim 21,
wherein a length of the contact surface in the first direction is longer than a length of the contact surface in the second direction.

23. The developing cartridge according to claim 21,
wherein the contact surface faces in the third direction.

24. The developing cartridge according to claim 1,
wherein the contact surface is a surface crossing the second direction.

25. The developing cartridge according to claim 24,
wherein the contact surface faces in the second direction.

26. The developing cartridge according to claim 1,
wherein the developing cartridge is attachable to a drum unit, the drum unit including a photosensitive drum and a drum electrode, and
wherein the contact surface is a surface in contact with the drum electrode in a state where the developing cartridge is attached to the drum unit.

27. The developing cartridge according to claim 26,
wherein the housing has a first end portion, the first end portion being a leading end during attachment of the developing cartridge to the drum unit, and
wherein the contact surface is positioned closer to the first end portion than the developing shaft is to the first end portion.

28. The developing cartridge according to claim 26,
wherein, in a state where the developing cartridge is attached to the drum unit, the developing roller is in contact with the photosensitive drum in the first direction.

29. The developing cartridge according to claim 26,
wherein the drum electrode is configured to press the contact surface toward the developing shaft.

30. The developing cartridge according to claim 1,
wherein the first direction crosses the second direction.

31. The developing cartridge according to claim 30,
wherein the first direction is orthogonal to the second direction.

32. The developing cartridge according to claim 1,
wherein the developing electrode is fixed to the housing with a screw, and
wherein the contact surface is positioned closer to the developing shaft than the screw is to the developing shaft.

33. The developing cartridge according to claim 1,
wherein the connection portion and the contact surface are formed as a single piece.

34. The developing cartridge according to claim 12,
wherein the developing cartridge is attachable to a drum unit, the drum unit including a photosensitive drum, and
wherein, in a state where the developing cartridge is attached to the drum unit, the contact surface is positioned further downward than the second bearing hole.

35. The developing cartridge according to claim 26,
wherein, in a state where the developing cartridge is attached to the drum unit, at least a part of the contact surface is positioned further downward than the developing shaft.

36. The developing cartridge according to claim 1,
wherein the contact surface is positioned at an end portion of the housing in the second direction.

37. The developing cartridge according to claim 1,
wherein the blade is configured to shape toner carried on the developing roller so that the toner has a predetermined thickness.
